(19) United States
(12) Patent Application Publication
(10) Pub. No.: US 2026/0153646 A1
(43) Pub. Date: Jun. 4, 2026

(54) SIMULATION TEST SYSTEM FOR MULTI-SCALE OVERLYING STRATA SPATIAL STRUCTURE EVOLUTION AND DISASTER RESPONSE AND WORKING METHOD THEREOF

(71) Applicant: SHANDONG UNIVERSITY OF SCIENCE AND TECHNOLOGY, Qingdao (CN)

(72) Inventors: Guangchao ZHANG, Qingdao (CN); Maosheng YIN, Qingdao (CN); Lianjun CHEN, Qingdao (CN); Zhaoyun ZHANG, Qingdao (CN); Kai LYU, Qingdao (CN); Guangtong LIU, Qingdao (CN); Shumeng CHEN, Qingdao (CN); Teng LEI, Qingdao (CN); Yuhang LIU, Qingdao (CN); Tong CHEN, Qingdao (CN)

(21) Appl. No.: 19/261,086

(22) Filed: Jul. 7, 2025

(30) Foreign Application Priority Data
Dec. 4, 2024 (CN) 202411766228.1

(51) Int. Cl. G01V 20/00

(52) U.S. Cl. CPC G01V 20/00

(57) ABSTRACT

The present disclosure relates to the technical field of mine mining simulation, and discloses a simulation test system for multi-scale overlying strata spatial structure evolution and disaster response and a working method thereof. The system includes a loading test host, a hydraulic station, a power distribution cabinet, and an industrial control computer. The loading test host includes a base, a main framework, a first top loading unit, a second top loading unit, a bottom excavation unit, a buffering energy release device, a telescopic rod group, and rock plate stamping device. The present disclosure has multiple working modes to achieve two-dimensional/three-dimensional simulation of the movement and response characteristics of overlying strata under conditions of large burial depth, strong mining vibration, and continuous mining of multiple working faces, and to simulate the entire process of coal mine vibration and seismogenic-triggering process of coal mine earthquakes.

### CROSS-REFERENCE TO RELATED APPLICATIONS

This application claims priority to Chinese Application No. 202411766228.1, filed on Dec. 4, 2024, entitled “SIMULATION TEST SYSTEM FOR MULTI-SCALE OVERLYING STRATA SPATIAL STRUCTURE EVOLUTION AND DISASTER RESPONSE AND WORKING METHOD THEREOF”. These contents are hereby incorporated by reference.

### TECHNICAL FIELD

The present disclosure relates to the technical field of mining simulation, in particular to a simulation test system for multi-scale overlying strata spatial structure evolution and disaster response and a working method thereof.

### BACKGROUND

Coal is the “ballast stone” and “stabilizer” for China's energy security and stable supply. Deep mining has become the norm for coal resource development, and the complex and intense activity of overlying rock layers, as well as the resulting safety hazards such as tunnel rupture, instability, and rockburst, are key factors restricting the safe and efficient mining of coal. The large-scale and intense activity of overlying strata and the resulting strong mining tremor and other dynamic disasters have become cutting-edge challenges for mining and safety disciplines worldwide. The overall research on the mechanism and prevention and control technology of strong mining tremor is difficult, and there are few related equipment. Currently, there is no specialized experimental equipment for studying the triggering mechanism of mining earthquakes at home and abroad, which makes it difficult to reveal the mechanical mechanism of triggering strong mining tremor at a deep level due to high-level thick hard rock strata breaking and unstable under multi working face and large space mining.

Research has found that there is a high demand for related scientific research, and single experiments using 3D simulation equipment are costly and difficult to operate. The current 2D or 3D simulation testing platforms for similar materials used in coal mining require different simulation equipment for different experiments. Therefore, it has to purchase different simulation testing equipment for different experiments, which has high equipment investment costs, requires multiple simulation testing equipment, occupies a large space, and incurs high maintenance costs. After searching relevant literature, it was found that the bottom of the existing similar material simulation test platform is a closed structure, which cannot achieve bottom excavation simulation of similar material models. In addition, the four side walls of the existing similar material simulation test platform are fixed, and the energy of the similar material model cannot be released during the top recording process, resulting in rock fractures during the loading process, thus, during the bottom excavation process, it cannot reflect the true situation of the entire seismogenic-triggering process of coal mine earthquakes. Therefore, the existing technology urgently needs to be further improved and enhanced.

### SUMMARY

In response to the shortcomings of the existing technologies mentioned above, the present disclosure provides a simulation test system for multi-scale overlying strata spatial structure evolution and disaster response. The technical solution adopted by the present disclosure is as follows:
A simulation test system for multi-scale overlying strata spatial structure evolution and disaster response includes a loading test host, a hydraulic station, a power distribution cabinet, and an industrial control computer, wherein the loading test host includes a base, a main framework, a first top loading unit, a second top loading unit, a bottom excavation unit, a buffering energy release device, a telescopic rod group, and a rock plate stamping device; the main framework is a square frame structure with openings at a front side and a rear side, and is fixedly installed on the base, two set of enclosure plates are respectively arranged on the front side and the rear side of the main framework, and the main framework is further provided with one set of a middle baffle.

An inner side of the main frame has a vertically arranged movable upright plate, and a lower end of the movable upright plate cooperates in a lateral sliding manner with a bottom of the main framework, the movable upright plate is adjustable and fixedly connected to a right side wall of the main framework through the telescopic rod group.

The buffering energy release device includes a buffer plate and spring components, the buffer plate is vertically adjacent to a left side of the movable upright plate, and there are a plurality of spring components arranged in a square array between the buffer plate and the movable upright plate, the buffer plate is connected to the movable upright plate through the spring components.

The first top loading unit and the second top loading unit are adjacent to each other at the top of the main framework, the first top loading unit includes at least two rows of first upper pressing plates arranged longitudinally adjacent to each other, each row of first upper pressing plates includes at least two first upper pressing plates arranged transversely adjacent to each other, and all of the first upper pressing plates are located between the buffer plate and a left side wall of the main framework.

The second top loading unit includes at least two second upper pressing plates located on a right side of the first upper pressing plate and arranged horizontally adjacent to each other, all of the second upper pressing plates correspond to positions of the first upper pressing plate on the fist front row and are linearly arranged, normal loading cylinders are arranged above each first upper pressing plate and each second upper pressing plate.

The bottom excavation unit includes a plurality of support plates arranged adjacent to each other in a square array, all of the support plates are movably arranged on a left side of the bottom of the main framework in an embedded manner, an excavation oil cylinder is arranged below each support plate, the excavating cylinder and the normal loading cylinder are independently supplied or returned oil by the hydraulic station.

Further, the main framework includes a bottom plate, a left side plate, a right side plate, and a crossbeam, the bottom plate is fixed to an upper surface of the base, the left side plate and the right side plate are vertically arranged opposite each other on a left side and a right side of the bottom plate, and lower ends of the left side plate and the right side plate are fixedly connected to the base.

The crossbeam is located directly above the bottom plate, and bottoms of a left end and a right end of the crossbeam are fixedly connected to upper ends of the left plate and the right plate, respectively.

Each of the bottom plate, the left side plate, the right side plate, and the crossbeam comprises a rectangular steel plate and a reinforced rib frame, and the reinforced rib frame is located on an outer wall of the rectangular steel plate and is fixedly welded into a whole.

Further, the first upper pressing plate, the second upper pressing plate, and the support plate are all square plates, and specifications of the first upper pressing plate and the second upper pressing plates are the same.

A square opening is formed on a left portion of the bottom plate, a square frame body matched to the square opening is fixed on the bottom plate in an embedded manner, all of the support plates are covered with an inner area of the square frame body, and four side walls of each of the support plates cooperates with the corresponding side of the adjacent support plate or an inner wall of the square frame body in a sealing and sliding manner.

Each excavating cylinder is fixed on the base, and an upper end of a piston rod of the excavating cylinder is fixedly connected to a center of the corresponding support plate, and drives the corresponding support plate to rise and fall.

Further, two sections of guide rails are fixed on an upper surface of a right portion of the bottom plate, the two sections of the guide rails are arranged in parallel and spaced apart from each other, each section of guide rails is provided with a guide slider that cooperates in a sliding manner with each guide rail, and each guide slider is fixedly connected to a bottom of the movable upright plate.

The telescopic rod group comprises a plurality of telescopic rods, all of the telescopic rods are arranged in a parallel and spaced distribution between the movable upright plate and the right side plate.

Each of the telescopic rods includes a bidirectional lead screw and two inner threaded cylinders, the bidirectional lead screw is horizontally arranged, with a rotation handle fixed in a middle position, the two inner threaded cylinders are arranged coaxially opposite each other on a left side and a right side of the bidirectional lead screw, and two ends of the bidirectional lead screw are respectively screwed into the corresponding ends of the two inner threaded cylinders.

A left end of the inner threaded cylinder located on the left side is fixedly connected to the movable upright plate, while a right end of the inner threaded cylinder located on the right side is fixedly connected to the right side plate; in the working state, the movable upright plate is driven to move left and right relative to the main framework by rotating the bidirectional lead screw through the rotation handle, achieving position adjustment of the movable upright plate.

Further, a front end face and a rear end face of the movable upright plate are both stepped surfaces formed by inward depressions of a left portion of the movable upright plate, the buffer plate is a C-shaped steel plate formed by a front end and a rear end of a steel plate is bent to the same side, folded edges on a front side and a rear side of the buffer plate are respectively attached to the front end face and the rear end face of the movable upright plate and cooperates in a sliding manner with the movable upright plate, and a cavity is formed between the buffer plate and a left side wall of the movable upright plate.

The folded edges on the front side and the rear side of the buffer plate are provided with a plurality of elongated holes vertically spaced apart, each of the plurality of elongated holes is provided with a limit bolt, each limit bolt is screwed onto the front end face or the rear end face of the movable upright plate.

Two slot openings are formed at a lower end of the buffer plate corresponding to positions of the two guide rails.

Further, each of the spring components comprises a guide pillar and a buffer spring, the guide pillar is transverse arranged horizontally, with an outside being sleeved with the buffer spring, a right end of the guide pillar is fixedly connected to the movable upright plate, a left end of the guide pillar passes through the buffer plate and is provided with a locking nut, the buffer spring is located between the buffer plate and the movable upright plate.

In working condition, a left side of the buffer plate moves to the right relative to the movable upright plate under external pressure, so as to press the buffer spring.

Further, a cylinder body of the normal loading cylinder is fixedly installed on the crossbeam, a lower end of the piston rod of the normal loading cylinder is fixedly connected to a center of the first upper pressing plate or the second upper pressing plate correspondingly through the same force sensor, and a signal terminal of the force sensor is connected to the industrial control computer for communication.

One guiding rod is arranged on each of the first upper pressing plate and the second upper pressing plate, each guiding rod is provided with a guiding sleeve, the guiding sleeve is fixed to the crossbeam, a lower end of the guiding rod is fixedly connected to a top of the first upper pressing plate or the second upper pressing plate correspondingly, and a upper end of the guiding rod is inserted inside the corresponding guiding sleeve and cooperates in a sliding manner.

Further, the rock plate stamping device includes a large pressing plate, a connecting column, and an installation plate, the installation plate is detachably installed at a bottom of each of the first upper pressing plates, the large pressing plate is located directly below the installation plate, and a center of a top of the large pressing plate is fixedly welded together with a bottom of the installation plate through the connecting column.

Further, each set of enclosure plates comprises a plurality of channel steels, each section of the channel steels in the same set is arranged adjacent to each other from bottom to top on the front side or the rear side of the main framework, and is fixedly connected to the left side plate, the right side plate, as well as the movable upright plate with bolts.

The middle baffle comprises a plurality of rectangular steel plates in strip shapes, all of the rectangular steel plates are arranged adjacent to each other from bottom to top between the left side plate and the buffer plate, a left end and a right end of each rectangular steel plate are respectively detachably and fixedly connected to the left side plate and the buffer plate.

Besides, the other objective of the present disclosure is to provide a working method for the simulation test system for multi-scale overlying strata spatial structure evolution and disaster response mentioned above, and the working method comprises following steps:
Step 1: in the initial state, all of the support plates are at a top dead center of their travel, and a top of each support plate is flush with a upper surface of a bottom plate of the main framework, adjusting all of the first upper pressing plates to the same height and position them at an upper part of the main framework; adjusting a position of the movable upright plate through the telescopic rod group, when a left side wall of the buffer plate contacts a right side wall of the rightmost first upper pressing plate, a position adjustment of the movable upright plate is completed.
Step 2: installing one enclosure plate respectively on the front side and the rear side of the main framework, laying a first layer of similar material on an area between the left side wall of the main framework and the buffer plate, leveling a surface of the first layer of similar material, and descending synchronously all of the first upper pressing plates to compact the first layer of similar material, then placing stress-strain gauges on the surface of the first layer of similar material, and connecting the stress-strain gauges to the industrial control computer through signal lines.
Step 3: installing the next one enclosure plate on the front side and the rear side of the main framework, laying the first layer of similar material, leveling, compacting, and placing stress-strain gauges in the same way as in step 2, laying each layer of similar material in sequence according to the above method, after the last layer of similar material is laid, not placing stress-strain gauges, and performing maintenance for the laid similar material model.
Step 4: after the maintenance of the similar material model is completed, the first upper pressing plates of the first top loading unit apply pressure to a top of the similar material model, at the same time, the excavating cylinder drives the corresponding support plates to move downward, separating from a bottom of the similar material model, for simulating continuous mining of multiple working faces, the stress and strain gauges send monitoring data to the industrial control computer, recording the stress changes of similar materials in each layer to determine a state of a rock layer.

Advantageous technical effects of the present disclosure are shown as below:

The present disclosure has multiple working modes, which are used for three-dimensional similar material simulation of the entire seismogenic-triggering process of coal mine earthquakes, as well as two-dimensional similar material simulation tests of two size specifications, and high, medium, and low rock plate loading simulation tests, to improve the universality and compatibility of the equipment and reduce equipment investment costs. In addition, the buffering energy release device of the present disclosure can avoid the occurrence of rock layer fracture under stress during the loading process before simulating bottom excavation, making the simulation of the entire seismogenic-triggering process of coal mine earthquakes closer to the real situation.

The simulation test system research platform provided by the present disclosure realizes the automation simulation of large-space mining with multiple working faces, which addresses the problems of large human interference and difficult observation of traditional test equipment. It realizes the simulation of the entire seismogenic-triggering process of coal mine earthquakes, and is expected to reveal the basic problems such as the joint evolution mechanism of thick-and-hard rock plate structure fracture instability and development and occurrence of strong mining tremors. The simulation test system for multi-scale overlying strata spatial structure evolution and disaster response realizes the two-dimensional/three-dimensional simulation of overlying rock movement and response characteristics under the conditions of large burial depth, strong mining tremors, and continuous mining of multiple working faces. It realizes the simulation of the entire seismogenic-triggering process of coal mine earthquakes, breaking through the technical bottlenecks of traditional simulation such as single dimension and difficulty in simulating disaster prone processes.

### BRIEF DESCRIPTION OF THE DRAWINGS

FIG. 1 is a structural schematic diagram of a simulation test system for multi-scale overlying strata spatial structure evolution and disaster response of the present disclosure.

FIG. 2 is a schematic diagram of the first working mode of the simulation test system for multi-scale overlying strata spatial structure evolution and disaster response.

FIG. 3 is a schematic diagram of a part in FIG. 2, showing the main framework.

FIG. 4 is a schematic diagram of another part in FIG. 2, showing the movable upright plate, buffering energy release device, and related parts.

FIG. 5 is a structural schematic diagram of the buffering energy release device shown in FIG. 4.

FIG. 6 is a sectional view of the movable upright plate and the buffering energy release device of the present disclosure.

FIG. 7 is a structural schematic diagram of the movable upright plate shown in FIG. 6.

FIG. 8 is a schematic diagram of the three-dimensional structure of the first top loading unit of the present disclosure.

FIG. 9 is a schematic diagram of the three-dimensional structure of the second top loading unit of the present disclosure.

FIG. 10 is a schematic diagram of the three-dimensional structure of the bottom excavation unit of the present disclosure.

FIG. 11 is a schematic diagram of the second working mode of the simulation test system for multi-scale overlying strata spatial structure evolution and disaster response.

FIG. 12 is a schematic diagram of the third working mode of the simulation test system for multi-scale overlying strata spatial structure evolution and disaster response.

FIG. 13 is a schematic diagram of the fourth working mode of the simulation test system for multi-scale overlying strata spatial structure evolution and disaster response.

Reference numbers in the drawings: 1. base; 2. main framework; 21. bottom plate; 211. rectangular steel plate; 212. reinforced rib frame; 213. square opening; 22. left side plate; 23. right side plate; 24. crossbeam; 25. enclosure plate; 26. middle baffle; 3. first top loading unit; 31. first upper pressing plate; 32. normal loading cylinder; 33. force sensor; 34. guiding rod; 35. guiding sleeve; 4. second top loading unit; 41. second upper pressing plate; 5. bottom excavation unit; 51. support plate; 52. excavation oil cylinder; 6. buffering energy release device; 61. buffer plate; 611, elongated hole; 612. slot; 613. folding section; 614. limit bolt; 62. guide pillar 63. buffer spring; 64. reinforcing plate; 65. locking nut; 71. large pressing plate; 72. connecting column; 73. installation plate; 8. movable upright plate; 81. guide rail; 82. guide slider; 83. bidirectional lead screw; 84. inner threaded cylinder; 85. rotation handle; 91. hydraulic station; 92. power distribution cabinet; 93. industrial control computer; 94. stress-strain gauge; 95. signal line.

### DETAILED DESCRIPTION OF THE EMBODIMENTS

In order to make the technical problems, technical solutions and beneficial effects of the present invention clearer, the present invention will be further described in detail below with reference to the accompanying drawings and embodiments

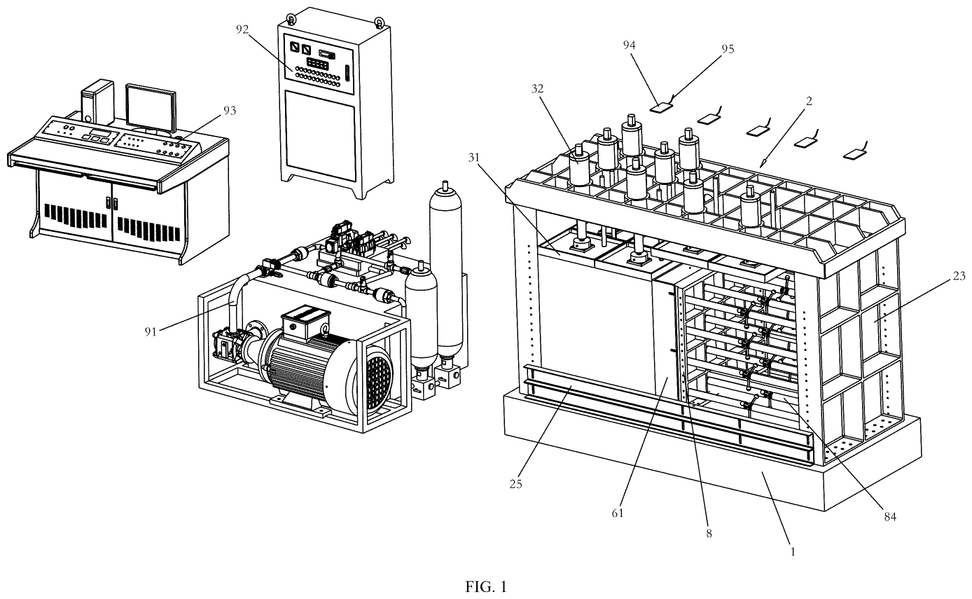

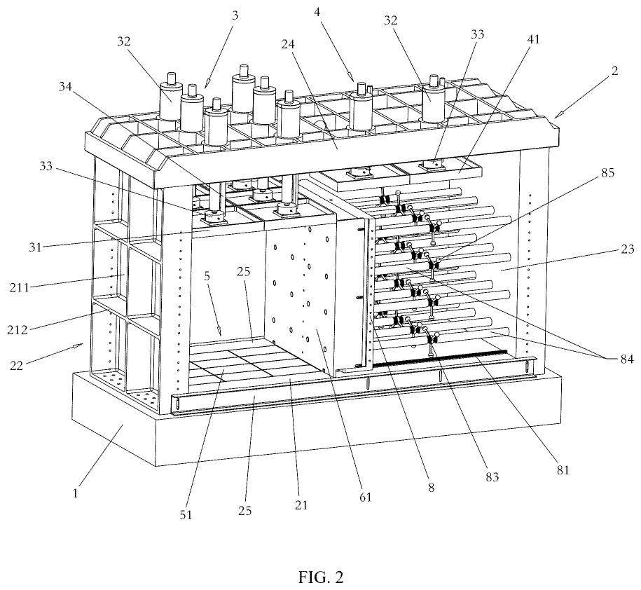

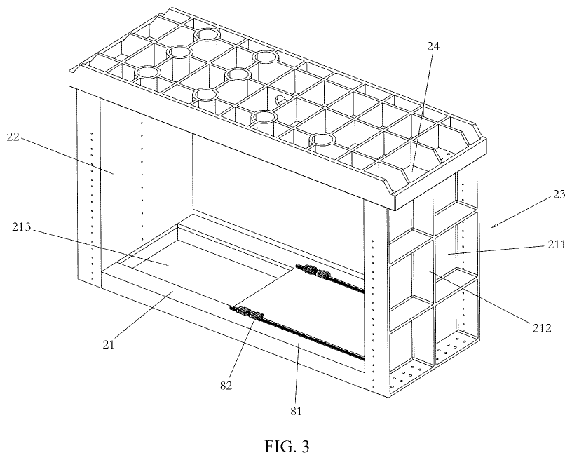

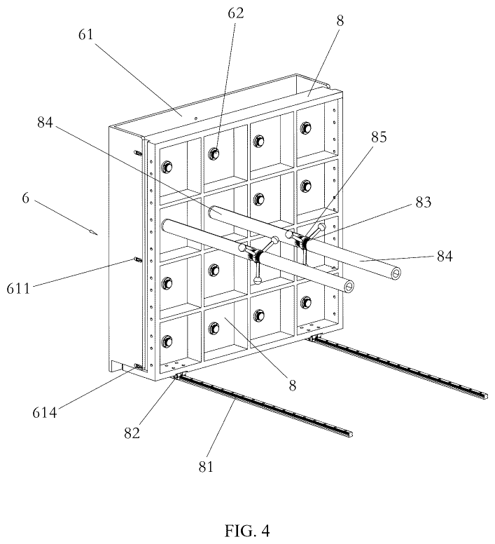

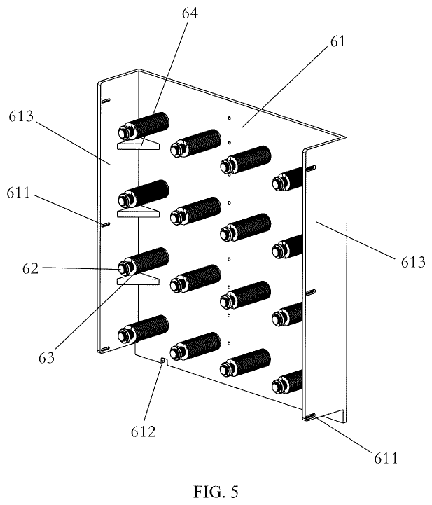

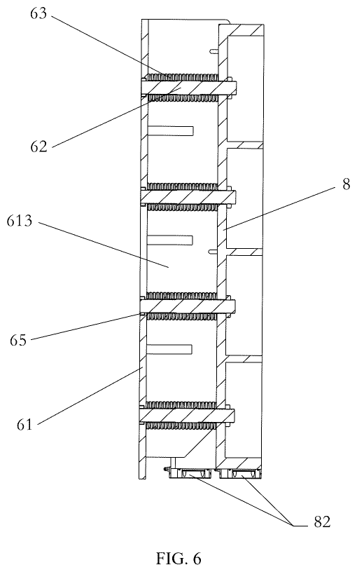

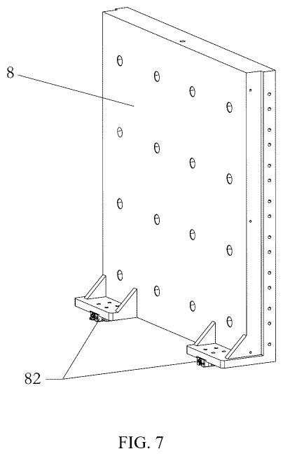

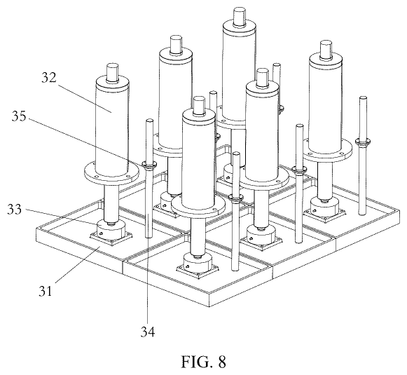

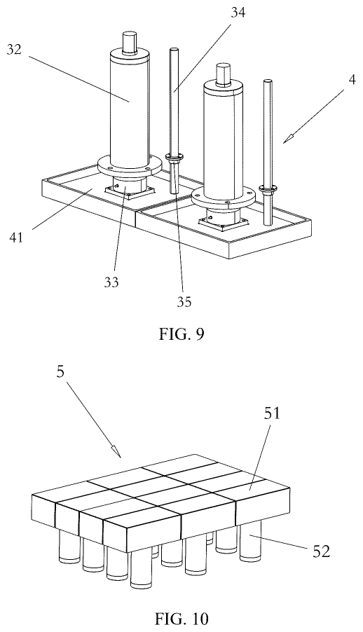

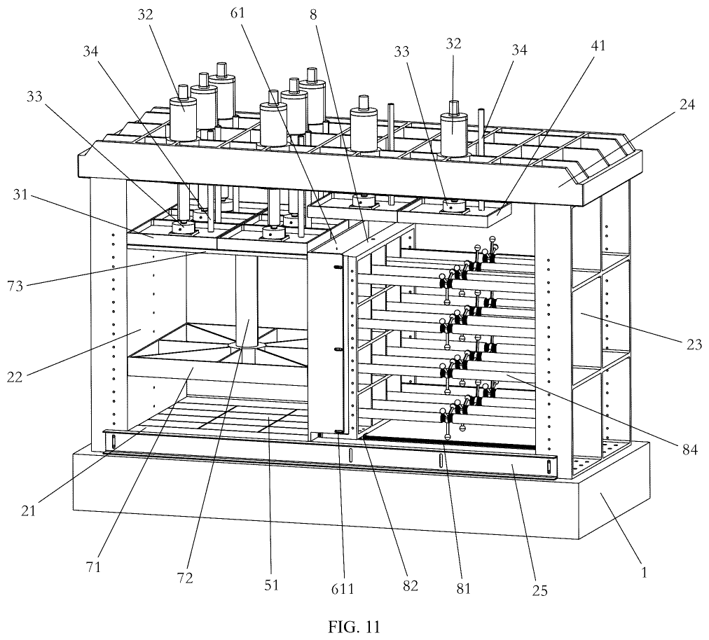

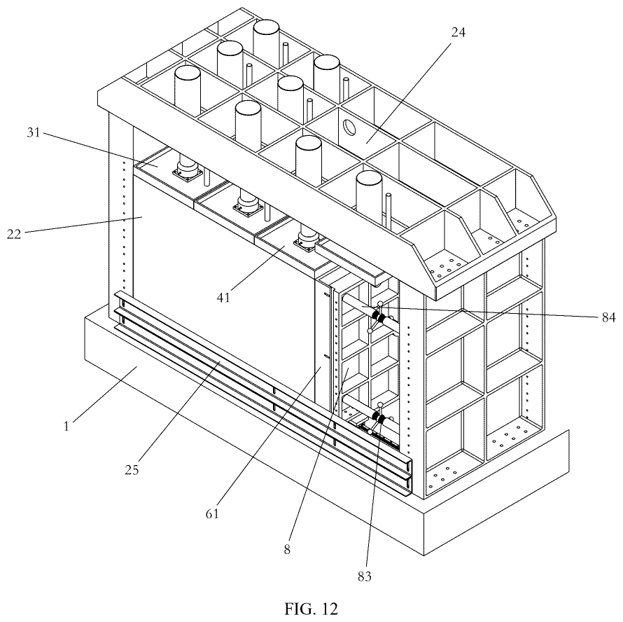

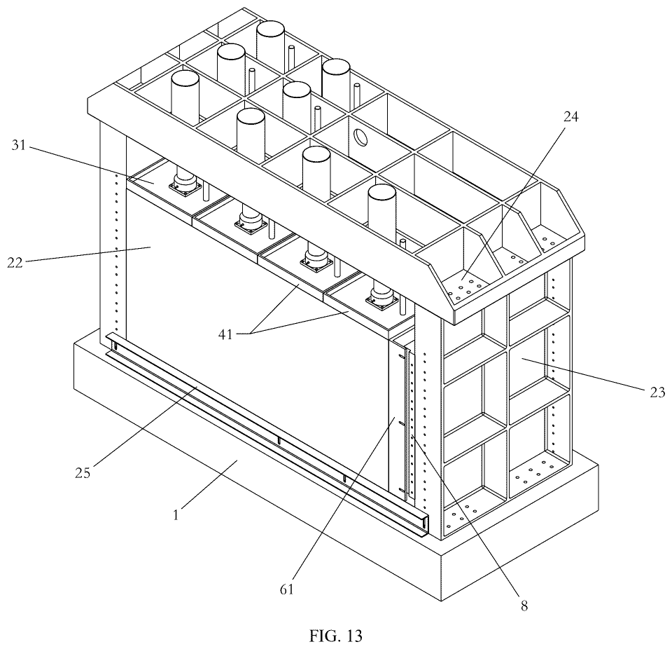

In embodiment 1, combined with FIGS. 1-13, the simulation test system for multi-scale overlying strata spatial structure evolution and disaster response is used to simulate and observe the three-dimensional and large space mining overlying rock evolution, mining earthquake occurrence and triggering mechanism in the mining field. The system includes a loading test host, a hydraulic station 91, a power distribution cabinet 92, and an industrial control computer 93. The loading test host includes a base 1, a main framework 2, a first top loading unit 3, a second top loading unit 4, a bottom excavation unit 5, a buffering energy release device 6, a telescopic rod group, and a rock plate stamping device. The main framework 2 is a square frame structure with openings at the front side and the rear side, and the main framework 2 is fixed on the base 1 by bolts.

Specifically, the main framework 2 includes a bottom plate 21, a left side plate 22, a right side plate 23, and a crossbeam 24. The bottom plate 21 is fixed to the upper surface of the base 1, the left side plate 22 and the right side plate 23 are vertically arranged opposite each other on the left side and the right side of the bottom plate 21, and the lower ends of the left side plate 22 and the right side plate 23 are fixedly connected to the base 1 through bolts. The crossbeam 24 is located directly above the bottom plate 21, and the bottoms of the left end and the right end of the crossbeam 24 are respectively connected to the upper ends of the left side plate 22 and the right side plate 23 by bolts. Specifically, the bottom plate 21, the left side plate 22, the right side plate 23, and the crossbeam 24 include rectangular steel plates 211 and reinforced rib frames 212. The reinforced rib frames 212 are located on the outer wall of the rectangular steel plates 211 and are fixedly welded into a whole. The bottom plate 21, the left side plate 22, the right side plate 23, and the crossbeam 24 have high stiffness, and the main framework 2 formed by their connection also has high stiffness and will not deform under large external forces.

Two set of enclosure plates 25 are respectively arranged on the front side and the rear side of the main framework 2. Each set of enclosure plates 25 includes a plurality of sections of channel steel. The sections of channel steels in the same set are arranged adjacent to each other from bottom to top on the front side or rear side of the main framework 2, and are fixedly connected to the left side plate 22, the right side plate 23, and the movable upright plate 8 with bolts. After the two sets of enclosure plates 25 are installed on the front side and the rear side of the main framework 2, similar materials are laid layer by layer on the inner side of the main framework 2. After solidification, a similar material model of simulating rock layer is formed.

The inner side of the main framework 2 has a vertically arranged movable upright plate 8, the lower end of the movable upright plate 8 cooperates in a lateral sliding manner with the bottom of the main framework 2, and the movable upright plate 8 is adjustably and fixedly connected to the right side wall of the main framework 2 through a telescopic rod group. Two sections of guide rails 81 are fixed on the upper surface of the right side of the bottom plate 21, the two sections of the guide rails 81 are arranged parallel and spaced apart from each other, one in front and one behind, each section of the guide rails 81 is provided with a guide slider 82 that cooperates in a sliding manner with it, and each guide slider 82 is fixedly connected to the bottom of the movable upright plate 8.

The telescopic rod group includes a plurality of telescopic rods, all of the telescopic rods are regularly arranged in a parallel and spaced manner between the movable upright plate 8 and the right side plate 23. Specifically, each of the telescopic rods includes a bidirectional lead screw 83 and two inner threaded cylinders 84. The bidirectional lead screw 83 is transverse arranged horizontally, with a rotation handle 85 fixed in the middle position, the two inner threaded cylinders 84 are arranged coaxially opposite each other on the left side and right side of the bidirectional lead screw 83, and the two ends of the bidirectional lead screw 83 are respectively screwed into the corresponding ends of the two inner threaded cylinders 84.

The left end of the inner threaded cylinder 84 located on the left side is fixedly connected to the movable upright plate 8, while the right end of the inner threaded cylinder 84 located on the right side is fixedly connected to the right side plate 23. In the working state, the movable upright plate 8 is driven to move left and right relative to the main framework 2 by rotating the bidirectional lead screw 83 through the rotation handle 85, the position adjustment of the movable upright plate 8 is achieved, thereby achieving the switching of test working modes between two-dimensional material simulation and three-dimensional similar material simulation.

The front end face and the rear end face of the movable upright plate 8 are both stepped surfaces formed by inward depressions of a left portion of the movable upright plate. The buffering energy release device 6 includes a buffer plate 61 and spring components, wherein the buffer plate 61 is vertically adjacent to the left side of the movable upright plate 8, and there are a plurality of spring components arranged in a square array between the buffer plate 61 and the movable upright plate 8, and the buffer plate 61 is connected to the movable upright plate 8 through spring components.

Specifically, the buffer plate 61 is a C-shaped steel plate formed by bending the front end and rear end to the same side. A plurality of reinforcing plates 64 are spaced on the inner side of the folding lines on the front side and rear side of the buffer plate 61, and the reinforcing plates 64 improve the overall stiffness of the buffer plate 61. The folding edges 613 on front side and rear side of the buffer plate 61 are respectively attached to the front end face and rear end face of the movable upright plate 8 and cooperates in a sliding manner with the movable upright plate 8, and a cavity is formed between the buffer plate 61 and the left side wall of the movable upright plate 8.

The folded edges 613 on the front side and rear side of the buffer plate 61 have a plurality of elongated holes 611 vertically spaced apart, and each of the elongated holes 611 is provided with a limit bolt 614, which is screwed onto the front end face or rear end face of the movable upright plate 8. Two slot openings 612 are formed at the lower end of the buffer plate 61 and one-to-one corresponding to the positions of the two guide rails 81. The buffer plate 61 can move on the two guide rails 81 along with the movable upright plate 8 and adjust the position together with the movable upright plate 8.

Specifically, each of the spring components includes a guide pillar 62 and a buffer spring 63. The guide pillar 62 is transverse arranged horizontally, the outside being sleeved with the buffer spring 63. The right end of the guide pillar 62 is fixedly connected to the movable upright plate 8, and the left end passes through the buffer plate 61 and is provided with a locking nut 65. The buffer spring 63 is located between the buffer plate 61 and the movable upright plate 8.

In working condition, the left side of the buffer plate 61 will move to the right relative to movable upright plate 8 under external pressure to press the buffer spring 63. Using this experimental system to simulate the entire seismogenic-triggering process of coal mine earthquakes, the buffer plate 61 can provide pressure release space for the similar material model during the top loading process before simulating bottom excavation of the similar material model, avoiding the occurrence of rock fractures before excavation.

The first top loading unit 3 and the second top loading unit 4 are installed adjacent to each other on the top of the main framework 2. The first top loading unit 3 includes three rows of first upper pressing plates 31 arranged longitudinally adjacent to each other, each row of first upper pressing plates 31 includes two first upper pressing plates 31 arranged transversely adjacent to each other. All first upper pressing plates 31 are located between the buffer plate 61 and the left side wall of the main framework 2.

The cylinder body of the normal loading cylinder 32 is fixedly installed on the crossbeam 24, and the lower end of the piston rod of the normal loading cylinder 32 is fixedly connected to the center of the corresponding the first upper pressing plate 31 or the second upper pressing plate 41 through a force sensor 33. The signal terminal of the force sensor 33 is connected to the industrial control computer 93 for communication.

A guiding rod 34 is arranged on each of the first upper pressing plate 31 and the second upper pressing plate 41, each of the guiding rods 34 is provided with a guiding sleeve 35, which is fixed to the crossbeam 24. The lower end of the guiding rod 34 is fixedly connected to the top of the corresponding the first upper pressing plate 31 or the second upper pressing plate 41, and the upper end of the guiding rod 34 is inserted inside the corresponding the guiding sleeve 35 and cooperates in a sliding manner with the guiding sleeve 35.

The second top loading unit 4 includes two the second upper pressing plates 41 located on the right side of the first upper pressing plate 31 and arranged laterally adjacent to each other. Two of the second upper pressing plates 41 correspond to the position of the first upper pressing plate 31 on the first front row and are linearly arranged. Normal loading cylinders 32 are arranged above each first upper pressing plates 31 and each second upper pressing plates 41.

The bottom excavation unit 5 includes twelve support plates 51 arranged adjacent to each other in a square array. The first upper pressing plate 31, the second upper pressing plate 41, and the support plate 51 are all rectangular plates, and the specifications of the first upper pressing plate 31 and the second upper pressing plate 41 are the same. Specifically, all the first upper pressing plate 31 and the second upper pressing plate 41 are made of rectangular steel plates of 500 mm×400 mm.

All the support plates 51 are movably arranged on the left side of the bottom of the main framework 2 in an embedded manner. A square opening 213 is formed on the left portion of the bottom plate 21, and a square frame body adapted to the square opening 213 is fixed on the bottom plate 21 in an embedded manner. All the support plates 51 are covered with the inner area of the square frame body, and the four side walls of each of the support plates 51 cooperates with the corresponding side of the adjacent support plate or an inner wall of the square frame body in a sealing and sliding manner. According to the simulation test system for multi-scale overlying strata spatial structure evolution and disaster response of the present disclosure, the non-invasive simulation of continuous mining of in multiple working faces is achieved, and for simulating small sheared type hydraulic elevating platform to mine automatically, the movement displacement speed of the twelve support plates 51 is 0.1 mm/min to 5 mm/min.

An excavating cylinder 52 is arranged below each support plate 51, and the excavating cylinder 52 is fixed on the base 1. The upper end of piston rod of the excavating cylinder 52 is fixedly connected to the center of the corresponding support plate 51, and drives the corresponding support plate 51 to rise and fall. The excavating cylinder 52 and the normal loading cylinder 32 are independently supplied or returned oil by the hydraulic station 91. The action of the telescopic ends of each excavating cylinder 52 and the normal loading cylinder 32 is controlled by a set program. Preferably, the excavating cylinder 52 is a small sheared type hydraulic elevating platform.

The rock plate stamping device includes a large pressing plate 71, a connecting column 72, and an installation plate 73. The installation plate 73 is detachably installed at the bottom of each of the first upper pressing plates 31. The large pressing plate 71 is located directly below the installation plate 73, and the top center of the large pressing plate 71 is fixedly welded together with the bottom of the installation plate 73 through the connecting column 72. The rock plate stamping device is used in the simulation test of high, medium and low rock plate loading. Specifically, the rock plate stamping device is installed at the bottom of the first upper pressing plate 31, and the normal loading cylinders 32 of the first top loading unit 3 synchronously expand or contract, driving the large pressing plate 71 to rise and fall vertically to load the rock plate located on the bottom plate 21.

In addition, the main framework 2 is further provided with a set of middle baffles 26, which include a plurality of rectangular steel plates in strip shape. All rectangular steel plates are arranged adjacent to each other from bottom to top between the left side plate 22 and the buffer plate 61. The left end and right end of the rectangular steel plates are respectively detachably and fixedly connected to the left side plate 22 and the buffer plate 61. The middle baffle 26 is used to seal the rear side of similar materials during the laying and loading process of two-dimensional similar material simulation tests.

The simulation test system for multi-scale overlying strata spatial structure evolution and disaster response of the present disclosure has four working modes. The first working mode is the simulation of the entire seismogenic-triggering process of coal mine earthquakes, the second working mode is the simulation test of 1.5 m two-dimensional similar materials, the third working mode is the simulation test of 2 m two-dimensional similar materials, and the fourth working mode is the simulation test of high, medium and low rock plate loading, simulating the fracture morphology of the plate structure and the obvious stress accumulation and fracture evolution process. Similar materials can use internally mixed quartz sand and externally sprayed concrete reinforcement to increase fracture brittleness and maintain fracture morphology without changing rock formation properties. The stress concentration monitoring method uses a resistivity meter. As the stress concentration density increases, the resistivity will change accordingly. A dynamometer measures the abutment pressure zone and the acting force between rock formations, which are suitable for the four working modes mentioned above. According to the present disclosure, various types of similar material simulation tests can be conducted, so that the equipment investment is reduced and the functionality is improved.

Embodiment 2, combined with FIGS. 1-13, based on the simulation test system for multi-scale overlying strata spatial structure evolution and disaster response described in embodiment 1, a working method of the simulation test system for multi-scale overlying strata spatial structure evolution and disaster response is provided, including the following steps:
Step 1: in the initial state, all the support plates 51 are at the top dead center of their travel, and the top of each support plate 51 is flush with the upper surface of the bottom plate of the main framework 2, adjusting all the first upper pressing plates 31 to the same height and positioning them at the upper part of the main framework 2.

Adjusting the position of the movable upright plate 8 through the telescopic rod group. When the left side wall of the buffer plate 61 contacts the right side wall of the rightmost first upper pressing plate 31, the position adjustment of the movable upright plate 8 is completed.

Step 2: installing an enclosure plate 25 on the front side and the rear side of the main framework 2; laying the first layer of similar material on the area between the left side wall of the main framework 2 and the buffer plate 61, then leveling the surface of the first layer of similar material, and then descending synchronously all of the first upper pressing plates 31 to compact the first layer of similar material; and then, placing stress-strain gauges 94 on the surface of the first layer of similar material and connecting the stress-strain gauges 94 to the industrial control computer 93 through signal lines 95.

Similar materials can use a composition consisting of organic matrix, lightweight sand plastic particles and binders, which have the advantageous of low density, low labor intensity in experiments, low environmental pollution, short waiting time for the experiment, and effectively control lithology. In addition, similar materials can also use a composition consisting organic matrix particles and lightweight sand as aggregates and concrete foaming agents, which have strong rigidity and can simulate the compressive strength of rock layers well, but have relatively low shear strength and tensile strength.

Step 3: installing the next enclosure plate on the front side and the rear side of the main framework 2, and laying the first layer of similar material, leveling, compacting, and placing stress-strain gauges 95 in the same way as in step 2; laying each layer of similar materials in sequence according to the above method; after the last layer of similar materials is laid, not placing stress-strain gauges 95, and maintaining the laid similar material model. Three-dimensional similar materials are easy to lay, homogeneous, readily obtainable, and can be well integrated with various types of monitoring devices

Step 4: after the maintenance of the similar material model is completed, the first upper pressing plates 3 of each first top loading unit 3 apply pressure to the top of the similar material model; at the same time, the excavating cylinder 52 drives the corresponding support plate 51 to move downward, separating from the bottom of the similar material model and simulating continuous mining of multiple working faces; the stress and strain gauges send monitoring data to the industrial control computer 93 to record the stress changes and fracture morphology of each layer of similar materials, and the development of internal cracks can be detected by ultrasonic waves.

In the present invention, the terms “first,” “second,” and “third” are merely for the purpose of description, but cannot be understood as indicating or implying relative importance. The term “multiple” means two or more unless otherwise explicitly defined. The terms “mount,” “connect with,” “connect,” “fix,” and the like shall be understood in a broad sense. For example, “connect” may mean being fixedly connected, detachably connected, or integrally connected; and “connect with” may mean being directly connected or indirectly connected through an intermediary. For those of ordinary skill in the art, specific meanings of the above terms in the present invention can be understood according to specific situations.

In the description of the present invention, it should be understood that if orientation or position relations indicated by the terms such as “upper,” “lower,” “left,” “right,” “front,” “back,” and the like are based on the orientation or position relations shown in the drawings, and the terms are intended only to facilitate the description of the present invention and simplify the description, rather than indicating or implying that the apparatus or element referred to must have a particular orientation and be constructed and operated in the particular orientation, and therefore cannot be construed as a limitation on the present invention.

Certainly, the above descriptions are merely preferred embodiments of the present disclosure. The present disclosure is not limited to the above embodiments listed. It should be noted that, all equivalent replacements and obvious variations made by any person skilled in the art under the teaching of the specification fall within the essential scope of the specification and shall be protected by the present disclosure.

What is claimed is:

1. A simulation test system for multi-scale overlying strata spatial structure evolution and disaster response, comprising a loading test host, a hydraulic station, a power distribution cabinet, and an industrial control computer, wherein the loading test host comprises a base, a main framework, a first top loading unit, a second top loading unit, a bottom excavation unit, a buffering energy release device, a telescopic rod group, and a rock plate stamping device; the main framework is a square frame structure with openings at a front side and a rear side, and is fixedly installed on the base, two set of enclosure plates are respectively arranged on the front side and the rear side of the main framework, and the main framework is further provided with one set of a middle baffle;
an inner side of the main frame has a vertically arranged movable upright plate, and a lower end of the movable upright plate cooperates in a lateral sliding manner with a bottom of the main framework, the movable upright plate is adjustable and fixedly connected to a right side wall of the main framework through the telescopic rod group;
the buffering energy release device comprises a buffer plate and spring components, the buffer plate is vertically adjacent to a left side of the movable upright plate, and there are a plurality of spring components arranged in a square array between the buffer plate and the movable upright plate, the buffer plate is connected to the movable upright plate through the spring components;
the first top loading unit and the second top loading unit are adjacent to each other at the top of the main framework, the first top loading unit comprises at least two rows of first upper pressing plates arranged longitudinally adjacent to each other, each row of first upper pressing plates comprises at least two first upper pressing plates arranged transversely adjacent to each other, all of the first upper pressing plates are located between the buffer plate and a left side wall of the main framework;
the second top loading unit comprises at least two second upper pressing plates located on a right side of the first upper pressing plate and arranged horizontally adjacent to each other, all of the second upper pressing plates correspond to positions of the first upper pressing plate on the fist front row and are linearly arranged, normal loading cylinders are arranged above each first upper pressing plate and each second upper pressing plate;
the bottom excavation unit comprises a plurality of support plates arranged adjacent to each other in a square array, all of the support plates are movably arranged on a left side of the bottom of the main framework in an embedded manner, an excavation oil cylinder is arranged below each support plate, the excavating cylinder and the normal loading cylinder are independently supplied or returned oil by the hydraulic station.

2. The simulation test system for multi-scale overlying strata spatial structure evolution and disaster response according to claim 1, wherein the main framework comprises a bottom plate, a left side plate, a right side plate, and a crossbeam, the bottom plate is fixed to an upper surface of the base, the left side plate and the right side plate are vertically arranged opposite each other on a left side and a right side of the bottom plate, and lower ends of the left side plate and the right side plate are fixedly connected to the base;
the crossbeam is located directly above the bottom plate, and bottoms of a left end and a right end of the crossbeam are fixedly connected to upper ends of the left plate and the right plate, respectively;
each of the bottom plate, the left side plate, the right side plate, and the crossbeam comprises a rectangular steel plate and a reinforced rib frame, and the reinforced rib frame is located on an outer wall of the rectangular steel plate and is fixedly welded into a whole.

3. The simulation test system for multi-scale overlying strata spatial structure evolution and disaster response according to claim 2, wherein the first upper pressing plate, the second upper pressing plate, and the support plate are all square plates, and specifications of the first upper pressing plate and the second upper pressing plates are the same;
a square opening is formed on a left portion of the bottom plate, a square frame body matched to the square opening is fixed on the bottom plate in an embedded manner, all of the support plates are covered with an inner area of the square frame body, and four side walls of each of the support plates cooperates with the corresponding side of the adjacent support plate or an inner wall of the square frame body in a sealing and sliding manner;
each excavating cylinder is fixed on the base, an upper end of a piston rod of the excavating cylinder is fixedly connected to a center of the corresponding support plate through a force sensor, and drives the corresponding support plate to rise and fall.

4. The simulation test system for multi-scale overlying strata spatial structure evolution and disaster response according to claim 2, wherein two sections of guide rails are fixed on an upper surface of a right portion of the bottom plate, the two sections of the guide rails are arranged in parallel and spaced apart from each other, each section of guide rails is provided with a guide slider that cooperates in a sliding manner with each guide rail, and each guide slider is fixedly connected to a bottom of the movable upright plate;
the telescopic rod group comprises a plurality of telescopic rods, all of the telescopic rods are arranged in a parallel and spaced distribution between the movable upright plate and the right side plate;
each of the telescopic rods comprises a bidirectional lead screw and two inner threaded cylinders, the bidirectional lead screw is horizontally arranged, with a rotation handle fixed in a middle position, the two inner threaded cylinders are arranged coaxially opposite each other on a left side and a right side of the bidirectional lead screw, and two ends of the bidirectional lead screw are respectively screwed into the corresponding ends of the two inner threaded cylinders;
a left end of the inner threaded cylinder located on the left side is fixedly connected to the movable upright plate, while a right end of the inner threaded cylinder located on the right side is fixedly connected to the right side plate; in the working state, the movable upright plate is driven to move left and right relative to the main framework by rotating the bidirectional lead screw through the rotation handle, achieving position adjustment of the movable upright plate.

5. The simulation test system for multi-scale overlying strata spatial structure evolution and disaster response according to claim 4, wherein a front end face and a rear end face of the movable upright plate are both stepped surfaces formed by inward depressions of a left portion of the movable upright plate, the buffer plate is a C-shaped steel plate formed by a front end and a rear end of a steel plate is bent to the same side, folded edges on a front side and a rear side of the buffer plate are respectively attached to the front end face and the rear end face of the movable upright plate and cooperates in a sliding manner with the movable upright plate, and a cavity is formed between the buffer plate and a left side wall of the movable upright plate;
the folded edges on the front side and the rear side of the buffer plate are provided with a plurality of elongated holes vertically spaced apart, each of the plurality of elongated holes is provided with a limit bolt, each limit bolt is screwed onto the front end face or the rear end face of the movable upright plate;
two slot openings are formed at a lower end of the buffer plate corresponding to positions of the two guide rails.

6. The simulation test system for multi-scale overlying strata spatial structure evolution and disaster response according to claim 1, wherein each of the spring components comprises a guide pillar and a buffer spring, the guide pillar is transverse arranged horizontally, with an outside being sleeved with the buffer spring, a right end of the guide pillar is fixedly connected to the movable upright plate, a left end of the guide pillar passes through the buffer plate and is provided with a locking nut, the buffer spring is located between the buffer plate and the movable upright plate; and
in working condition, a left side of the buffer plate moves to the right relative to the movable upright plate under external pressure, so as to press the buffer spring.

7. The simulation test system for multi-scale overlying strata spatial structure evolution and disaster response according to claim 3, wherein a cylinder body of the normal loading cylinder is fixedly installed on the crossbeam, a lower end of the piston rod of the normal loading cylinder is fixedly connected to a center of the first upper pressing plate or the second upper pressing plate correspondingly through the same force sensor, and a signal terminal of the force sensor is connected to the industrial control computer for communication;
one guiding rod is arranged on each of the first upper pressing plate and the second upper pressing plate, each guiding rod is provided with a guiding sleeve, the guiding sleeve is fixed to the crossbeam, a lower end of the guiding rod is fixedly connected to a top of the first upper pressing plate or the second upper pressing plate correspondingly, and a upper end of the guiding rod is inserted inside the corresponding guiding sleeve and cooperates in a sliding manner.

8. The simulation test system for multi-scale overlying strata spatial structure evolution and disaster response according to claim 1, wherein the rock plate stamping device comprises a large pressing plate, a connecting column, and an installation plate, the installation plate is detachably installed at a bottom of each of the first upper pressing plates, the large pressing plate is located directly below the installation plate, and a center of a top of the large pressing plate is fixedly welded together with a bottom of the installation plate through the connecting column.

9. The simulation test system for multi-scale overlying strata spatial structure evolution and disaster response according to claim 2, wherein each set of enclosure plates comprises a plurality of channel steels, each section of the channel steels in the same set is arranged adjacent to each other from bottom to top on the front side or the rear side of the main framework, and is fixedly connected to the left side plate, the right side plate, as well as the movable upright plate with bolts;
the middle baffle comprises a plurality of rectangular steel plates in strip shapes, all of the rectangular steel plates are arranged adjacent to each other from bottom to top between the left side plate and the buffer plate, a left end and a right end of each rectangular steel plate are respectively detachably and fixedly connected to the left side plate and the buffer plate.

10. A working method for the simulation test system for multi-scale overlying strata spatial structure evolution and disaster response, wherein based on the simulation test system for multi-scale overlying strata spatial structure evolution and disaster response according to claim 1, the working method comprises following steps:
step 1: in the initial state, all of the support plates are at a top dead center of their travel, and a top of each support plate is flush with a upper surface of a bottom plate of the main framework, adjusting all of the first upper pressing plates to the same height and position the first upper pressing plates at an upper part of the main framework;
adjusting a position of the movable upright plate through the telescopic rod group, when a left side wall of the buffer plate contacts a right side wall of the rightmost first upper pressing plate, a position adjustment of the movable upright plate is completed;
step 2: installing one enclosure plate respectively on the front side and the rear side of the main framework, laying a first layer of similar material on an area between the left side wall of the main framework and the buffer plate, leveling a surface of the first layer of similar material, and descending synchronously all of the first upper pressing plates to compact the first layer of similar material, then placing stress-strain gauges on the surface of the first layer of similar material, and connecting the stress-strain gauges to the industrial control computer through signal lines;
step 3: installing the next one enclosure plate on the front side and the rear side of the main framework, laying the first layer of similar material, leveling, compacting, and placing stress-strain gauges in the same way as in step 2, laying each layer of similar material in sequence according to the above method, after the last layer of similar material is laid, performing maintenance for the laid similar material model;
step 4: after the maintenance of the similar material model is completed, the first upper pressing plates of the first top loading unit apply pressure to a top of the similar material model, at the same time, the excavating cylinder drives the corresponding support plates to move downward, separating from a bottom of the similar material model, the stress and strain gauges send monitoring data to the industrial control computer, recording the stress changes of similar materials in each layer to determine a state of a rock layer.
